(19) United States
(12) Patent Application Publication
(10) Pub. No.: US 2011/0088593 A1
(43) Pub. Date: Apr. 21, 2011

(54) SILVER DZ NANO-FLUID COMPOSITION FOR NANO-FIN FORMATION AND A METHOD OF PRODUCING THE SAME

(76) Inventor: Mansour Hemmati, TEHRAN (IR)

(21) Appl. No.: 12/977,096

(22) Filed: Dec. 23, 2010

(51) Int. Cl. C09D 1/00; B82Y 99/00

(52) U.S. Cl. 106/287.18; 977/773

(57) ABSTRACT

The various embodiments herein provide a nano-fluid for formation of nano-fins for use in power-plants, automobile industry and machineries comprising a metallic-ion supplier material, a base fluid, a plurality of stabilizer material and a regenerative agent. The metallic-ion supplier material includes a nano-powder of silver acetate or silver nitrate. The base fluid is deionized water. The regenerative agent is sodium borohydrate. The plurality of stabilizer material includes tri-ethanol-amine-lauryl-ether sulphate, hydroxyl-propyl-ammonium-chloride, coconut-pheti-acid-diethanolamide, coco-amido-propyl-ethanol and sodium chloride. The embodiments herein also provide a rapid and in-expensive method of producing the nano-fluid. The embodiments herein also provide a new stabilizer composition for stabilizing the nano-fluid comprising a combination of an anionic surfactant, a non-ionic surfactant, a cationic surfactant, an amphoteric surfactant and a salt.

The present invention, for international filling is partially sponsored by Iranian Nanotechnology Initiative Counsel.

### BACKGROUND

1. Technical Field

The embodiments herein generally relate to fin structures used for thermal transfer systems in powerplants, automobiles, buildings and machineries. The embodiments herein particularly relate to nano fin structures and more particularly to nano-fluids such as DZ nano fluids for forming nano fin structures.

2. Description of the Related Art

Nano-fluids are stable suspensions containing nano-particles. Nano-fluids are produced by dispersing nano-particles in a base-fluid. Nano-fluids are classified by the type of nano-particles, surfactants and stabilizers used along with them. Nano-fluids enhance the efficiency of heat exchangers by increasing the heat transfer coefficient.

There have been methods to produce nano-fluids wherein firstly the nano-particles are produced and then dispersed using ultrasonic waves. But these methods are costly and non-economic for high volume production in industries.

In most of scientific researches, the volume percentage of nano-particles in nano-fluids or nano-based coolants has been reported to be between 1-10%, which is very high. This makes some serious problems in industrial processes such as variation in fluid viscosity which leads to changing the design and structure of the system and pumps, clogging of pipes in heat exchangers due to settlement of the nano-particles in high volume percentages, probable corrosions and low stability. The boundary layer thickness also plays an important role in increasing the stability of nano particles, but has an adverse effect on heat transfer. Because of these serious problems, the industrialization of such products has become difficult. Moreover, there is no practical industrial product commercially available in the market.

Hence there is need to produce a nano-fluid with remarkable features which can be easily produced and widely industrialized.

The above mentioned shortcomings, disadvantages and problems are addressed herein and which will be understood by reading and studying the following specification.

### OBJECTIVES OF THE EMBODIMENTS

The primary object of the embodiments herein is to develop a nano-fluid to increase the effective heat transfer surface of the heat exchangers by forming nano-fins.

Another object of the embodiments herein is to develop a nano-fluid with an extraordinary adhesive capability to metallic surfaces to form nano fins.

Yet another object of the embodiments herein is to develop a nano-fluid to form nano fins to increase the heat transfer coefficient of a fluid by 20 to 30 times.

Yet another object of the embodiments herein is to develop a nano-fluid with wide industrial applications.

Yet another object of the embodiments herein is to provide a nano-fluid that does not clog a pipe of various heat transfer plants or systems.

Yet another object of the embodiments herein is to develop a nano-fluid that can be used in all kinds of heat transfer systems and needs no change in system structure and pump design.

Yet another object of the embodiments herein is to develop a nano-fluid that makes the internal surface of pipes in heat exchangers corrosion proof.

Yet another object of the embodiments herein is to develop a nano-fluid that can be used in all kinds of vehicle radiators and cooling systems.

Yet another object of the embodiments herein is to develop a nano-fluid that can be used in almost all parts of a power plant to increase the energy efficiency.

Yet another object of the embodiments herein is to develop a nano-fluid that can be used in refrigeration for increasing the efficiency of refrigeration systems by forming a nano-fin on the internal surface of pipes that transfer working gas or fluid.

Yet another object of the embodiments herein is to develop a nano-fluid that can be easily sprayed on metallic surfaces to form nano fin structures.

Yet another object of the embodiments herein is to develop a nano-fluid that can be used on the surfaces of internal copper elements, wirings and cables of generators and electro motors for increasing total efficiency.

Yet another object of the embodiments herein is to develop a simple, reproducible and inexpensive method to produce a highly stable nano-fluid.

Yet another object of the embodiments herein is to develop a method that does not need any device, equipment or any other apparatus or lateral system and is performed in ambient temperatures without using any electromagnetic radiations.

These and other objects and advantages of the embodiments herein will become readily apparent from the following detailed description taken in conjunction with the accompanying drawings.

### SUMMARY

The various embodiments herein provide a composition and a method of producing a DZ nano-fluid for forming nano fin structures.

According to an embodiment herein, a nano-fluid composition for formation of nano-fins for use in power-plants and automobile industry comprises a base fluid, a metallic-ion supplier material, a plurality of stabilizing material and a regenerative agent. The base fluid is de-ionized water. The metallic-ion supplier material is a nano-powder selected from a group comprising silver acetate and silver nitrate. The nano-powder has nano-particles with spherical shape and a size of 5-7 nanometers. The plurality of stabilizing material comprises an anionic surfactant, a cationic surfactant, a non-ionic surfactant, an amphoteric surfactant and a salt. The anionic surfactant includes tri-ethanol-amine-lauryl-ether sulphate. The non-ionic surfactant includes hydroxyl-propyl-ammonium-chloride. The cationic surfactant includes coconut-pheti-acid-diethanolamide. The amphoteric surfactant includes coco-amido-propyl-ethanol and the salt includes sodium chloride. The tri-ethanol-amine-lauryl-ether sulphate is added in an amount of 100 ppm/liter. The coco-amido-propyl-ethanol is added in an amount of 100 ppm/liter. The coconut-pheti-acid-di-ethanol amide is added in an amount of 100 ppm/liter. The hydroxyl-propyl-ammonium-chloride is added in an amount of 20 ppm/liter and the sodium chloride is added in an amount of 20 ppm/liter. The regenerative agent is sodium borohydrate. The nano-fluid is used in a concentration of 25 ppm or 0.0025 volume percentage.

According to another embodiment herein, a method of producing a nano-fluid for formation of nano-fins for use in power-plants and automobile industry wherein a nano-powder of a metallic-ion supplier material is added to a pre-determined amount of a base fluid to form a solution. A plurality of stabilizing material is added to the solution. A regenerative agent is added to the solution. The nano-fluid is produced in a temperature of less than 10° C. and at a pH of 8. The nano-powder of metallic-ion supplier material is selected from a group comprising silver acetate and silver nitrate. The nano-powder of metallic-ion supplier material has nano-particles with a spherical shape and a size of 5-7 nanometers. The base fluid is deionized water and the pre-determined amount of base fluid is 1 liter. The plurality of stabilizing material comprises an anionic surfactant, a non-ionic surfactant, a cationic surfactant, an amphoteric surfactant and a salt, wherein the anionic surfactant includes tri-ethanol-amine-lauryl-ether sulphate, the non-ionic surfactant includes hydroxyl-propyl-ammonium-chloride, the cationic surfactant includes coconut-pheti-acid-diethanolamide, the amphoteric surfactant includes coco-amido-propyl-ethanol and the salt includes sodium chloride. The tri-ethanol-amine-lauryl-ether sulphate is added to the base fluid in an amount of 100 ppm/liter. The amount of coco-amido-propyl-ethanol added is 100 ppm/liter. The coconut-pheti-acid-di-ethanol amide is added in an amount of 100 ppm/liter while the hydroxyl-propyl-ammonium-chloride is added in an amount of 20 ppm/liter. The sodium chloride is added in an amount of 20 ppm/liter. The regenerative agent is sodium borohydrate. The produced nano-fluid is used as a spray on an internal and external surface for formation of nano-fins. The nano-fluid is active for a minimum period of 3 years.

According to one embodiment herein, the method of producing nano-fluid, a metal ion cultivating component is added to a base fluid to a preferred extent. Then a stabilizer is added to the above solution. Finally a reducing component or a regenerative material is supplemented to the solution under ultraviolet rays and at a temperature of below 10° C. and pH of 8. The metal ion cultivating component used herein is silver acetate or silver nitrate, wherein silver acetate is the more preferred component. The base fluid used herein is deionized water. The stabilizer includes triethanolamine-lauryl-ether sulphate, coco-amido-propyl-ethanol, coconut-pheti-acid-diethanolamide, hydroxyl-propyl-ammonium-chloride and sodium chloride. The reducing component or regenerative material used herein is natrium/sodium borohydrate. The nano-particles are 5-7 nanometers in size and spherical in shape.

According to another embodiment herein, a nano-fluid composition for formation of nano fin structures used in powerhouses, automotives and machinery comprises a metal ion cultivating component, a base fluid, a stabilizer and a regenerative agent. The metal ion cultivating component is a nano-powder selected from a group comprising silver acetate and silver nitrate. The nano-powder has nano-particles of size 5-7 nanometers and the nano particles are in spherical in shape. The base fluid is de-ionized water. The stabilizer further comprises tri-ethanol-amine-lauryl-ether sulphate added in an amount of 100 ppm/liter, coco-amido-propyl-ethanol in an amount of 100 ppm/liter, coconut-pheti-acid-diethanolamide with an amount of 100 ppm/liter, hydroxyl-propyl-ammonium-chloride with an amount of 20 ppm/liter and sodium chloride with an amount of 20 ppm/liter. The regenerative is sodium borohydrate. The nano-fluid is used at a concentration of 25 ppm/liter. The nano-fluid forms a nano-fin. The nano-fluid is used as a spray on internal or external surfaces.

According to one embodiment herein, the method of producing a nano-fluid for forming nano fins used in powerhouses, automotives and machinery comprises adding a nano-powder of metal ion cultivating component to a base fluid at a pre-determined amount to form a solution. Then a stabilizer is added to the solution and after that a regenerative material is added to the solution. The nano-fluid is produced in a temperature of less than 10° C. and at a pH of 8. The nano-powder of metal ion cultivating component is selected from a group comprising silver acetate and silver nitrate. The nano-powder of metal ion cultivating component has nano-particles of spherical shape with a size of 5-7 nanometers. The base fluid herein is deionized water and the pre-determined amount of base fluid is 1 liter. The stabilizer includes tri-ethanol-amine-lauryl-ether sulphate added at an amount of 100 ppm/liter, coco-amido-propyl-ethanol with an amount of 100 ppm/liter, coconut-pheti-acid-diethanolamide with an amount of 100 ppm/liter, hydroxyl-propyl-ammonium-chloride with an amount of 20 ppm/liter and sodium chloride with an amount of 20 ppm/liter. The regenerative material herein is sodium borohydrate.

According to an embodiment herein, a new stabilizer composition or formulation for stabilizing a nano-fluid comprises an anionic surfactant, a non-ionic surfactant, an amphoteric surfactant, a cationic surfactant and a salt. The anionic surfactant includes tri-ethanol-amine-lauryl-ether sulphate. The non-ionic surfactant includes hydroxyl-propyl-ammonium-chloride. The amphoteric surfactant includes coco-amido-propyl-ethanol. The cationic surfactant is coconut-pheti-acid-diethanolamide. The salt is sodium chloride.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a flow chart indicating the steps for producing the nano-fluid of an embodiment herein.

FIG. 2A shows a molecular structure of a metallic nano particle in a nano-fluid of an embodiment herein.

FIG. 2B shows a border stratum formed with metallic nano particles of a nano-fluid of an embodiment herein.

FIG. 2C shows a magnified view of the border stratum formed with metallic nano particles of a nano-fluid of an embodiment herein, on a surface of a metal.

FIG. 2D shows the mechanism of formation of border stratum on and between the surface of a metal and nano-particle molecules.

### DETAILED DESCRIPTION OF THE EMBODIMENTS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The term “nano-fluid” and “DZ nano-fluid” used herein are interchangeable.

The DZ nano-fluid herein has new inventive features with respect to other nano fluids that use polymeric or protein stabilizers. The new stabilizer component formulation herein does not decrease the surface potential of nano particles. So the particles are enabled to connect the internal surfaces of heat exchangers by making nano-fins on the surface of metals. The DZ nano-fluid of the embodiment herein is used to achieve the efficiency attained by the use of other nanofluids, even when the DZ nano fluid is used at an amount of obtained 25 ppm per liter which is 40 times less than the amount of other nano-fluids used.

The term “nano-fin” used herein refers to a disc that is formed on the metallic surfaces or blades which is used in thermal converters like car radiators and air conditioners to increase the surface area in use. The Fin leads to an enhancement of constant volume of the converter, amount of heat convection and converter's efficiency. According to the various embodiments herein, the metallic nano-particles in DZ nano-fluid are capable of attachment at different metal surfaces to enhance heat transfer efficiency. This leads to an improvement in the efficiency of the thermal converters. The level of attachment of these nano particles to the metal surfaces is optimum and they are resistant to passing fluids such as water and air.

According to the various embodiments herein, the nano-fluid works on two mechanisms: firstly, it increases the heat transfer coefficient or operative fluid thermal conduction coefficient of base fluid through a reduction of thermal heat capacity coefficient of base fluid or the operative fluid and secondly, it increases the effective heat transfer surface area of heat exchangers by forming a nano-fin on the surface and increasing the transformer rim surface.

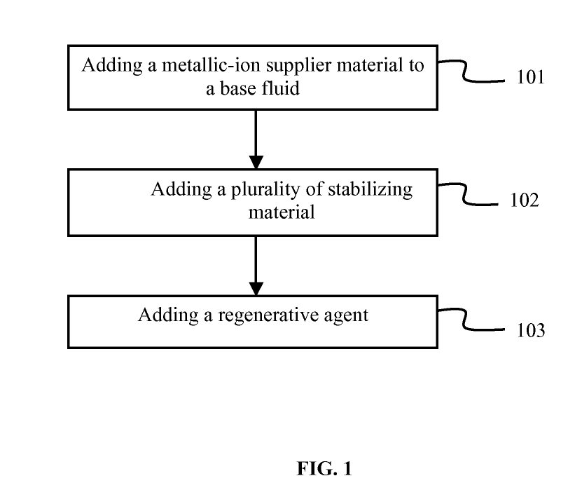

FIG. 1 illustrates a flow chart showing the steps for producing the nano-fluid. With respect to FIG. 1, the method of producing a nano-fluid for use in powerhouses, automotives and machinery comprises firstly a nano-powder of metallic-ion supplier material is added to a pre-determined amount of base fluid to form a solution (101). Then a plurality of stabilizer material is added to the solution (102) and after that a regenerative agent is added to the solution (103). The nano-fluid is produced in a temperature of less than 10° C. and pH of 8. The nano-powder of metal ion cultivating component is selected from a group comprising silver acetate and silver nitrate. The nano-powder of metal ion cultivating component has nano-particles of size 5-7 nanometers and is spherical in shape. The base fluid herein is deionized water and the pre-determined amount of base fluid is 1 liter. The stabilizer includes tri-ethanol-amine-lauryl-ether sulphate with an amount of 100 ppm/liter, coco-amido-propyl-ethanol with an amount of 100 ppm/liter, coconut-pheti-acid-diethanolamide with an amount of 100 ppm/liter, hydroxyl-propyl-ammonium-chloride with an amount of 20 ppm/liter and sodium chloride with an amount of 20 ppm/liter. The regenerative material herein is sodium borohydrate.

The method of producing the nano-fluid, according to the embodiments herein, is cheaper than the other methods because nano particles in the base fluid are synthesized without using any apparatus and used in the same shape as produced. But in the other methods, the solid nano particles are first to be dispersed by a sound creator device (sound waves) and are used afterwards. This process is almost impossible or very expensive for an industrial production scale.

According to an embodiment herein, the DZ nano-fluid is produced without any peripheral machinery or tool and is used directly after the distillation of nano fluid. This causes low cost production. Owing to nano-fin formation herein, the DZ nano-fluid utilizes 60% of the nano characteristics after draining the nano-fluid from any reservoir. In an equal volume percentage of nano particles, DZ nano fluid increases the heat transfer coefficient of the fluid by 20 to 30 times more as compared to other nano fluids. In a volume percentage of 25 ppm, the DZ nano-fluid intensifies the heat transfer coefficient of the coolant fluids up to 15% in a power heat exchanger or a power plant and has no effect on increment of base fluid viscosity.

According to an embodiment herein, a new stabilizer composition or formulation for stabilizing a nano-fluid comprises an anionic surfactant, a non-ionic surfactant, a cationic surfactant, an amphoteric surfactant and a salt. The anionic surfactant includes tri-ethanol-amine-lauryl-ether sulphate. The non-ionic surfactant includes hydroxyl-propyl-ammonium-chloride. The amphoteric surfactant includes coco-amido-propyl-ethanol. The cationic surfactant includes coconut-pheti-acid-diethanolamide and the salt includes sodium chloride.

The surfactants are active surface materials that can take part into chemical interactions on their own surface and reduce surface tension. Surfactants are derived from compositions called fatty acids. Fatty acids are considered as natural materials that can be achieved through plant and animal sources. According to the embodiments herein, the fatty acids used herein are selected from a group comprising palm kernel oil, coconut oil and soybean oil. Surfactants are both fat-friendly and water-friendly. Surfactants have a kind of specific structure which is chemically divided into four groups namely anionic, cationic, amphoteric and non-ionic. According to the embodiments herein, the anionic surfactant includes tri-ethanol-amine-lauryl-ether sulphate, the non-ionic surfactant includes hydroxyl-propyl-ammonium-chloride, the amphoteric surfactant includes coco-amido-propyl-ethanol and the cationic surfactant includes coconut-pheti-acid-diethanol-amide.

The addition of surfactants to the solution prevents conglomeration and do not decrease the surface characteristics of nano particles which transfers surface electrostatic potential of the nano particles and connect them on the metallic surface. The chemical components used herein in the DZ nano fluid for dispersing and stabilizing the nano-particles, create exclusive characteristics for nano-particles present in the nano-fluid such as they do not decrease the surface potential and keep the thickness of boundary layer optimum which helps the nano-particles to attach on the metallic surfaces resulting in the formation of a nano-fin on the metallic surfaces. The particles are enabled to connect to internal surfaces of heat exchangers by making nano-fins on the surface of metals.

The Regenerative agent is a chemical substance that is used in chemical reactions that provide electrons and turn the metal ions into metal atoms. Regenerative substances are applied in almost all nano-particle synthesis. According to various embodiments herein, the regenerative materials used herein is sodium boron hydrate. The Sodium Boron Hydrate is a very strong regenerative agent.

According another embodiment herein, a nano-fluid composition of 1 liter of DZ nano-fluids (1000 ppm) includes tri-ethanol-amine-lauryl-ether sulphate with an amount of 100 ppm/liter, coco-amido-propyl-ethanol with an amount of 100 ppm/liter, coconut-pheti-acid-diethanolamide with an amount of 100 ppm/liter, hydroxyl-propyl-ammonium-chloride with an amount of 20 ppm/liter, and sodium chloride with an amount of 20 ppm/liter.

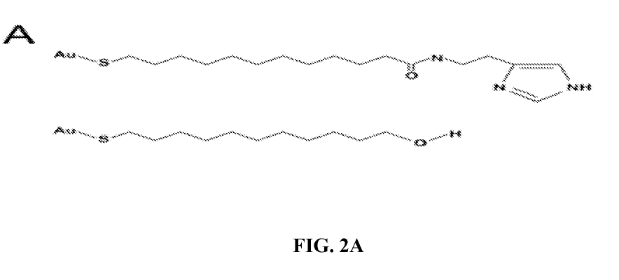

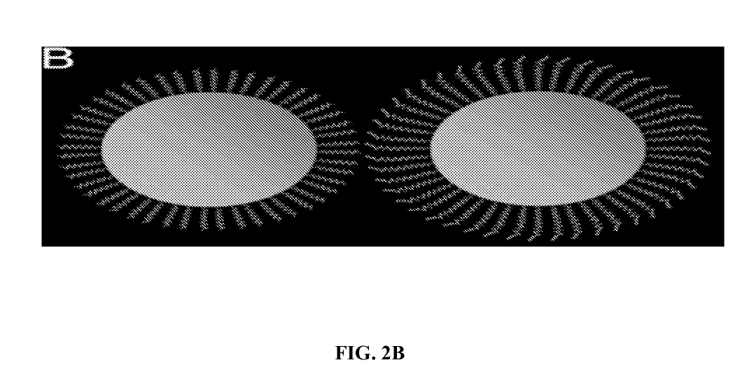

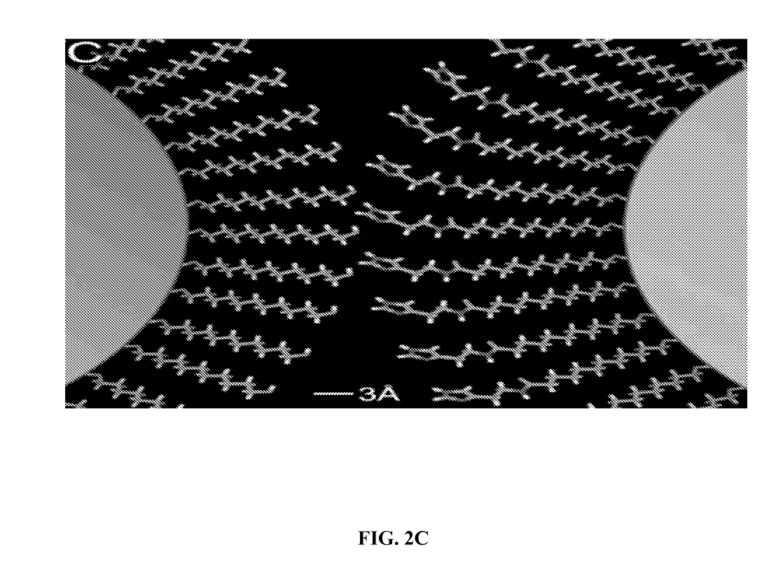

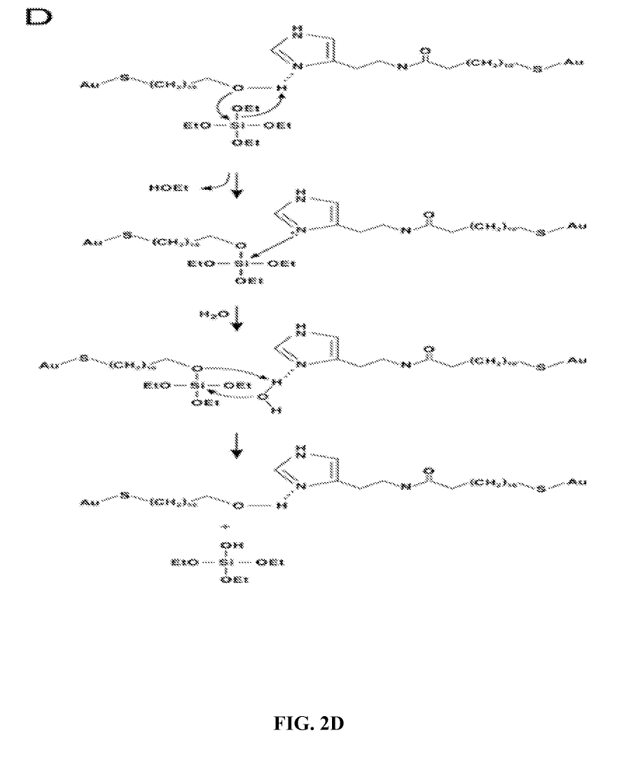

FIG. 2A shows a molecular structure of a metallic nano particle in a nano-fluid of an embodiment herein. With respect to FIG. 2A, the nano particle is attached to the surface of a metal to form a nano fin structure. The border stratum prevents attachment of nano-particles with each other. Border stratum is made up of different molecules such as polymer, fat, protein and surfactant molecules. The Border stratum is formed on the border between the fluid and the metal. Both the material and thickness of this stratum play an important role in transfer of surface properties of nano-particles. The more the thickness of the stratum, the less the heat transfer from nano-particle surfaces.

FIG. 2B shows a border stratum formed with metallic nano particles of a nano-fluid of an embodiment herein. With respect to FIG. 2B, the long chain of nano-particles forms a border stratum on the metal surface.

FIG. 2C shows a magnified view of the border stratum formed with metallic nano particles of a nano-fluid of an embodiment herein, on a surface of a metal. There is an optimum formation of border-stratum among the nano-particles herein which prevents the attachment of nano-particles with each other and also do not affects the heat transfer. The nano-particles do not coagulate and do not form lumps. So less surface electric charge of nano-particles is transferred to the metallic surface. The diameter of the border stratum has an important role in increasing the stability of nano-particles. But it has negative effect on the heat transmission. According to the embodiments herein, the surface properties of the nano-particles are not reduced. The surface electro-static potential is transmitted to metallic surfaces. This causes the conjunction of the nano particles to the metallic surfaces and thus formation of nano-fins.

FIG. 2D shows the mechanism of formation of border stratum on and between the surface of a metal and nano-particle molecules. With respect to FIG. 2D, the tetraethyl orthosilicate molecule gets attached to the oxygen atom of the hydroxyl group of the surfactant and releasing one O-Ethyl molecule. After accepting a lone pair of electrons from the N atom of second surfactant molecule and taking a water molecule, the surfactant molecules are attached together releasing the tetraethyl orthosilicate molecule.

The border stratum prevents attachment of nano-particles with each other. Border stratum is made up of different molecules such as polymer, fat, protein and surfactant molecules. The Border stratum is formed on the border between the fluid and the metal. Both the material and thickness of this stratum play an important role in transfer of surface properties of nano-particles. The more the thickness of the stratum, the less the heat transfer from nano-particle surfaces. There is less formation of border-stratum among the nano-particles herein which prevents the attachment of nano-particles with each other. The nano-particles do not coagulate and do not form lumps. So less surface electric charge of nano-particles is transferred to the metallic surface. The diameter of the border stratum has an important role in increasing the stability of nano-particles. But it has negative effect on the heat transmission.

According to the embodiments herein, the surface properties of the nano-particles are not reduced. The surface electro-static potential is transmitted to metallic surfaces. This causes the conjunction of the nano particles to the metallic surfaces and thus formation of nano-fins.

The DZ nano-fluid herein can be used in powerhouses, automotives and machinery. The DZ nano-fluid can be used in all kinds of vehicle radiators and cooling systems wherein by adding the DZ nano fluid to the coolant of radiators, the heat transfer rate of internal surface of the cooling system is increased by which the number of times and period of the turning on/off of the cooling fan is decreased. The DZ nano-fluids can be used in all industrial cooling systems and chillers wherein the cooling gas is used. After spraying the DZ nano fluid and after the formation of nano-fin on the internal copper piping, the heat transfer efficiency is increased. The DZ nano-fluid can be used in automobile industry wherein by using DZ nano fluids constantly, the size of cooling system and the electrical characteristics of the cooling fans in the vehicles are decreased. The DZ nano-fluid can be used in large sized Power Plants. DZ Nano Fluids can be used in almost all parts of these plants to increase their energy efficiency. For example, electricity generation efficiency of the plants is increased by using DZ nano fluids in cooling system of the generators. The DZ nano-fluid forms nano-fins on external surfaces by spraying the DZ nano fluids on the surfaces or submerging cooling systems and on different exchangers, generators and electro motors' copper parts, electronic devices, CPU heat sinks etc. By the formation of nano-fin the external surfaces of these elements, the working rate and heat transfer efficiency is increased.

### Experimental Data

All the methods used for diagnosing the stability of nano-fluid are based on superficial factors, color stability and degree of formation of sediments in nano-fluid solutions. There is no standard defined for diagnosing the stability of nano-particles except the superficial factors.

A number of tests were conducted on six different types of car radiators in wind tunnel of Iran Radiator Company to prove the efficiency of DZ nano-fluid. The cars had problem of boiling over either in traffic or when their air conditioners were on. The results expressed enhancements in efficiency of heat transfer. After one hour and a half of using the DZ nano-fluid in all the cases, no radiators boiled over neither in the traffic nor when their air conditioners were switched on. In some of the cases, even after expelling the DZ nano fluid from the engine, 60% of cooling effect remained due to the formation of nano-fin on the internal rim of the radiators.

In the next stage, the DZ nano-fluid was applied to the power plant generators. After two years also, the improvements can be observed in the cooling effect on generators. All these evidences add to the stability of DZ nano-fluid.

The laboratory of university producing nano material sampled and diagnosed the DZ nano-fluid for 5 years and found no sedimentation. Also the samples observed and chosen by CAFA Company (the executive of nano center) checked the efficiency of DZ nano-fluid in various industrial plants and machineries. The DZ nano-fluid has been proved efficient in transferring heat from the metallic surfaces and has shown more stability, appearance constancy, and no change in color and no sediment deposit.

Also, the DZ nano-fluid, used in various industrial converters, did not show any effect in enhancement of heat convection efficiency for two years. This can be considered as scientific and experimental proofs for stability of DZ nano particles.

In all the reported nano-fluids, the main mechanism of increasing the efficiency of heat transfer in converters is the enhancement of conduction heat transfer. In other words, when nano-particles enter the engine, they heat up at least 600 times more than water molecules and when they come to the radiator they get cooled by at least 600 times more than water molecules. Generally, to increase the heat conduction coefficient up to 10%, the volume percent of nano-particles should be much higher which leads to the sedimentation of nano-particles and increases the cost of production. This also causes an increase in viscosity which is also dangerous. The DZ nano fluid herein creates the same increase in efficiency by nano-fin formation which increases the surface of heat transfer with a very low density i.e. 25 ppm or 0.0025 volume percentages.

Although the embodiments have been described in some detail by way of illustration and example for the purposes of clarity of understanding, it is clearly not limited thereby and this invention encompass any changes and modifications that may be practiced within the scope of the appended claims by ones skilled in the art.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims. It is also to be understood that the following claims are intended to cover all of the generic and specific features of the embodiments described herein and all the statements of the scope of the embodiments which as a matter of language might be said to fall there between.

What is claimed is:

1. A nano-fluid composition for formation of nano-fins for use in power-plants and automobile industry comprising:
a base fluid;
a metallic-ion supplier material;
a plurality of stabilizing material; and
a regenerative agent.

2. The composition according to claim 1, wherein the base fluid is de-ionized water.

3. The composition according to claim 1, wherein the metallic ion supplier material is a nano-powder selected from a group comprising silver acetate and silver nitrate.

4. The composition according to claim 3, wherein the nano-powder has nano-particles with a spherical shape and a size of 5-7 nanometers.

5. The composition according to claim 1, wherein the plurality of stabilizing material comprises an anionic surfactant, a non-ionic surfactant, a cationic surfactant, an amphoteric surfactant and a salt; wherein the anionic surfactant includes tri-ethanol-amine-lauryl-ether sulphate, wherein the non-ionic surfactant includes hydroxyl-propyl-ammonium-chloride, wherein the cationic surfactant includes coconut-pheti-acid-diethanolamide, wherein the amphoteric surfactant includes coco-amido-propyl-ethanol and wherein the salt includes sodium chloride.

6. The composition according to claim 5, wherein the tri-ethanol-amine-lauryl-ether sulphate is added in an amount of 100 ppm/liter, wherein the coco-amido-propyl-ethanol is added in an amount of 100 ppm/liter, wherein the coconut-pheti-acid-di-ethanol amide is added in an amount of 100 ppm/liter, wherein the hydroxyl-propyl-ammonium-chloride is added in an amount of 20 ppm/liter and wherein the sodium chloride is added in an amount of 20 ppm/liter.

7. The composition according to claim 1, wherein the regenerative agent is sodium borohydrate.

8. The composition according to claim 1, wherein the nano-fluid is used at a concentration of 25 ppm.

9. A method of producing a nano-fluid for formation of nano-fins for use in power-plants and automobile industry comprising the steps of:
adding a nano-powder of a metallic-ion supplier material to a pre-determined amount of a base fluid to form a solution;
adding a plurality of stabilizing material to the solution; and
adding a regenerative agent to the solution.

10. The method according to claim 9, wherein the nano-fluid is produced at a temperature of less than 10° C. and a pH of 8.

11. The method according to claim 9, wherein the nano-powder of metallic-ion supplier material is selected from a group comprising silver acetate and silver nitrate.

12. The method according to claim 11, wherein the nano-powder of metallic-ion supplier material has nano-particles with a spherical shape and a size of 5-7 nanometers.

13. The method according to claim 9, wherein the base fluid is deionized water.

14. The method according to claim 9, wherein the pre-determined amount of base fluid is 1 liter.

15. The method according to claim 9, wherein the plurality of stabilizing material comprises an anionic surfactant, a non-ionic surfactant, a cationic surfactant, an amphoteric surfactant and a salt, wherein the anionic surfactant includes tri-ethanol-amine-lauryl-ether sulphate, wherein the non-ionic surfactant includes hydroxyl-propyl-ammonium-chloride, wherein the cationic surfactant includes coconut-pheti-acid-diethanolamide, wherein the amphoteric surfactant includes coco-amido-propyl-ethanol, and wherein the salt includes sodium chloride.

16. The method according to claim 15, wherein the tri-ethanol-amine-lauryl-ether sulphate is added in an amount of 100 ppm/liter, wherein the coco-amido-propyl-ethanol is added in an amount of 100 ppm/liter, wherein the coconut-pheti-acid-di-ethanol amide is added in an amount of 100 ppm/liter, wherein the hydroxyl-propyl-ammonium-chloride is added in an amount of 20 ppm/liter and wherein the sodium chloride is added in an amount of 20 ppm/liter.

17. The method according to claim 9, wherein the regenerative agent is sodium borohydrate.

18. The method according to claim 9, wherein the produced nano-fluid is used as a spray on an internal and external surface for formation of nano-fins.

19. The method according to claim 9, wherein the nano-fluid is active for a minimum period of 3 years.
